(19) United States
(12) Patent Application Publication
(10) Pub. No.: US 2003/0235422 A1
(43) Pub. Date: Dec. 25, 2003

(54) Image forming apparatus

(75) Inventor: Masaaki Oyaide, Shizuoka-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/177,101

(22) Filed: Jun. 24, 2002

(51) Int. Cl. G03G 15/20

(52) U.S. Cl. 399/69; 399/70

(57) ABSTRACT

An image forming apparatus according to the invention is provided with a warming-up mode, standby mode and print mode for controlling the heating of a to-be-heated object that is used to fix an image transferred onto a paper sheet. For example, in the warming-up mode for heating, to a predetermined temperature, the to-be-heated object used to fix an image transferred onto a paper sheet, a second heater lamp for heating the to-be-heated object with a rated power lower than a predetermined rated power is turned on and time measurement is started. After a predetermined time period t1 elapses, a first heater lamp for heating the to-be-heated object with the predetermined rated power is turned on, thereby heating the to-be-heated object to a predetermined temperature while detecting the temperature of the to-be-heated object using a detecting section for detecting the temperature.

### BACKGROUND OF THE INVENTION

1. Field of the Invention

The present invention relates to an image forming apparatus, such as a printer, copy machine, facsimile, complex machine, etc., which is provided with a fixing unit for thermally fixing an image transferred onto a paper sheet.

2. Description of the Related Art

An image forming apparatus is known which is provided with a fixing unit for fixing an image transferred onto a paper sheet by heating a to-be-heated object using a heater lamp. In order to prevent an inrush current (flicker) that occurs when a heater lamp is turned on, an apparatus provided with a plurality of heater lamps has been proposed. In such an image forming apparatus, if, for example, two heater lamps are employed, one of the heater lamps is first turned on, and the other heater lamp is turned on a predetermined period after, in order to mainly prevent an inrush current when the heater lamps are turned on. In other words, the two heater lamps are turned on at different timings.

Further, an image forming apparatus has been proposed in which an inrush current is prevented by switching the connection of two heater lamps between a series connection and parallel connection. An image forming apparatus has also been proposed in which switching control is executed so as to equalize the lives of a plurality of heater lamps employed therein.

The specifications for each of the above-described heater lamps are designed to enable a maximum power to be output during a printing operation, and also to shorten the warming-up period. Accordingly, when all the heater lamps are tuned on, the amount of heat generated by them is excessive. This means that if all the heater lamps are turned on, the preset target temperature is reached in a short time. Upon detecting that the target temperature is reached, the heater lamps are turned off. However, since an excessive amount of heat is supplied in a short time, a temperature higher than the target temperature may be reached. This phenomenon is called “overshooting”. As described above, in the image forming apparatuses proposed so far, there is a tendency for the variations in the range of a controlled target temperature, i.e., the temperature ripple, to increase.

Thus, in the above-described image forming apparatuses, although an inrush current can be prevented, using a plurality of heater lamps, a great temperature ripple occurs during temperature control of the to-be-heated object in the warming-up mode, printing mode, standby mode, etc.

### BRIEF SUMMARY OF THE INVENTION

It is an object of the invention to provide an image forming apparatus in which the temperature ripple is reduced by controlling, in accordance with predetermined conditions, the turn-on and -off of a plurality of heater lamps provided for heating a to-be-heated object that is used to fix an image.

An image forming apparatus according to an aspect of the invention is an apparatus for executing predetermined image forming, and comprises: a to-be-heated object which thermally fixes an image transferred onto a paper sheet; a first heater lamp heats the to-be-heated object with a predetermined rated power; a second heater lamp which heats the to-be-heated object with a rated power lower than the predetermined rated power; a timer section which measures time; a detecting section which detects a temperature of the to-be-heated object; and at least one of a warming-up mode, standby mode and print mode, as an operation mode configured to control the heating of the to-be-heated object.

The warming-up mode is an operation mode in which the to-be-heated object is heated from a cold start temperature to a predetermined temperature. In the warming-up mode, the second heater lamp is turned on and time measurement is started. The first heater lamp is turned on after a predetermined time period t1 elapses, thereby heating the to-be-heated object to the predetermined temperature.

The standby mode is an operation mode in which the to-be-heated object is maintained at a print-enabling temperature, and a request for printing is waited for. In the standby mode, turn-on and turn-off of the second heater lamp is executed preferentially, and the second heater lamp is turned on and time measurement is started. The first heater lamp is turned on if a preset target temperature is not reached even after a predetermined time period t3 elapses, thereby heating the to-be-heated object to a temperature falling within a predetermined range.

The print mode is an operation mode for predetermined image printing, in which the to-be-heated object is controlled to execute thermal fixing. In the print mode, turn-on and turn-off of the first heater lamp is executed preferentially, and the first heater lamp is turned on and time measurement is started. The second heater lamp is turned on if a preset target temperature is not reached even after a predetermined time period t2 elapses, thereby heating the to-be-heated object to a temperature falling within a predetermined range.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic sectional view illustrating a printer according to an embodiment of the invention;

FIG. 2 is a view useful in explaining the structure for controlling the heating of a heater roller;

FIG. 3 is a table showing the temperature control logic in warming-up mode;

FIG. 4 is a table showing the temperature control logic in standby mode;

FIG. 5 is a table showing the temperature control logic in printing mode; and

FIG. 6 is a view useful in explaining temperature control.

### DETAILED DESCRIPTION OF THE INVENTION

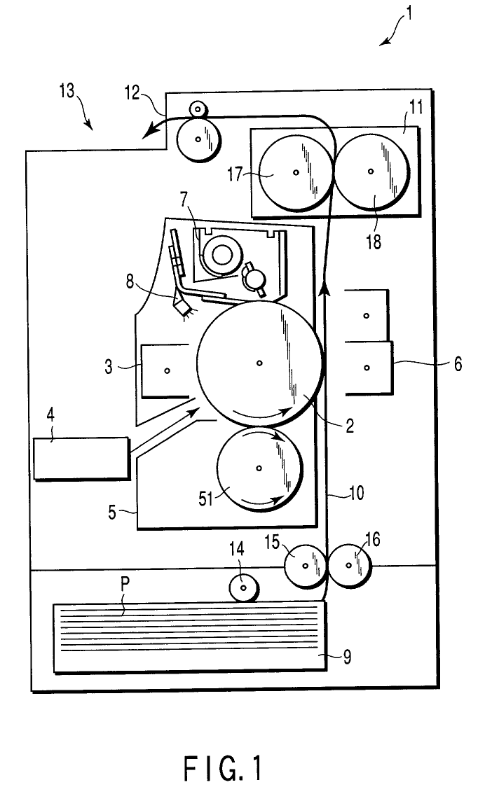

An embodiment in which an image forming apparatus according to the invention is used in a printer 1 as shown in FIG. 1 will be described with reference to the accompanying drawings.

As shown in FIG. 1, a photosensitive drum 2, which rotates counterclockwise in the figure, is provided at substantially the center of the cross section of the printer 1. A charger 3, exposure unit 4, developing unit 5, transfer unit 6, cleaning unit 7 and de-electrifying LED 8 are provided around the photosensitive drum 2.

A drawable cassette 9 is housed in the bottom portion of the printer 1. Paper sheets P are received in the cassette 9. A conveyance path 10 for the paper sheets P extends from the cassette 9 to a discharge port 12 via the space between the photosensitive drum 2 and transfer unit 6 and via a fixing unit 11 provided at the upper right side of the photosensitive drum 2. Each paper sheet P discharged from the discharge port 12 is received in a paper receiving section 13. Each paper sheet P is forwarded to the conveyance path 10 by a pickup roller 14. Then, each paper sheet is guided between the photosensitive drum 2 and transfer unit 6 by conveyance rollers 15 and 16 opposing each other, with the conveyance path 10 interposed there between.

The charger 3 uniformly charges the periphery of the photosensitive drum 2 with a predetermined charge.

The exposure unit 4 emits a laser beam through the route indicated by the arrow in the figure, thereby scanning the periphery of the photosensitive drum 2 to form an electrostatic latent image thereon.

The developing unit 5 supplies a developing roller 51 with a developer supplied from a developer hopper, thereby converting the electrostatic latent image on the photosensitive drum 2 into a developer image.

The transfer unit 6 transfers the developer image formed on the photosensitive drum 2, onto each paper sheet P.

The cleaning unit 7 clears the remaining developer from the periphery of the photosensitive drum 2.

The fixing unit 11 has a heater roller 17 as a to-be-heated object, and a pressure roller 18. The fixing unit 11 fixes the developer image, transferred to each paper sheet P, by heating the developer image using the heater roller 17, and pressing it using the pressure roller 18.

In the printer 1, while the photosensitive drum 2 having its periphery charged by the charger 3 is rotating, the exposure unit 4 emits a laser beam to form a predetermined electrostatic latent image on the periphery of the photosensitive drum 2, and the developing unit 5 develops the electrostatic latent image. In the printer 1, in synchronism with the development of the image, the pickup roller 14 and conveyance rollers 15 and 16 are rotated to convey a paper sheet between the photosensitive drum 2 and transfer unit 6, whereby the developer image is transferred onto the paper sheet. In the printer 1, the paper sheet P with the developer image transferred is guided to the fixing unit 11, where the developer image is thermally fixed on the paper sheet. The resultant paper sheet P is discharged through the paper discharge port 12. In the above-described manner, the printer 1 prints out a predetermined image on a paper sheet P.

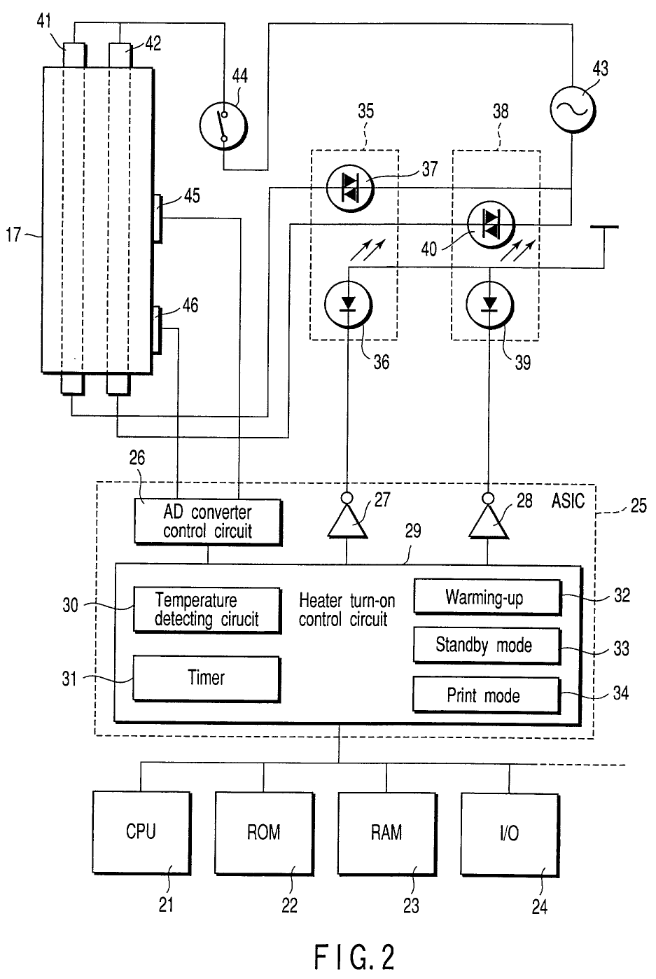

Heating control by the heater roller 17 will now be described. As shown in FIG. 2, a CPU 21, ROM 22, RAM 23, I/O port 24 and ASIC 25 are connected to a system bus.

The ASIC 25 contains an A/D converter control circuit 26, drive circuit 27, drive circuit 28 and heater turn-on control circuit 29.

The heater turn-on control circuit 29 contains a temperature detecting circuit 30 and timer 31. The heater turn-on control circuit 29 executes heat control on the heater roller 17 in warming-up mode 32, standby mode 33 or print mode 34.

A signal line extends from the drive circuit 27 to a photo triac 35. This signal line is connected to a DC power supply (not shown) via a light emission section 36 provided in the photo triac 35. The photo triac 35 also incorporates a light receiving section 37 for receiving light emitted from the light emission section 36.

A signal line extends from the drive circuit 28 to a photo triac 38. This signal line is connected to the DC power supply (not shown) via a light emission section 39 provided in the photo triac 38. The photo triac 39 also incorporates a light receiving section 40 for receiving light emitted from the light emission section 39.

The roller heater 17 is provided with a heater lamp 41 with a rated power of 600 W and a heater lamp 42 with a rated power of 300 W. An end of the heater lamp 41 is connected to an AC power supply 43 via the light receiving section 37 of the photo triac 35. An end of the heater lamp 42 is connected to the AC power supply 43 via the light receiving section 40 of the photo triac 38. The other ends of the heater lamps 41 and 42 are connected to the AC power supply 43 via a thermostat 44 for preventing excessive heating. The heater lamps 41 and 42 are connected in parallel to the AC power supply 43.

Accordingly, if a signal is supplied from the drive circuit 27, the light emission section 36 of the photo triac 35 emits light. If the light receiving section 37 receives the light, the heater lamp 41 is connected to the AC power supply 43. As a result, the heater lamp 41 is turned on. If the drive circuit 27 transmits no signal, the light emission section 36 emits no light. At this time, since the light receiving section 37 detects no light, the heater lamp 41 is not connected to the AC power supply 43. As a result, the heater lamp 41 is not turned on.

Using the same mechanism as the above, the turn-on and -off of the heater lamp 42 is executed. Since the turn-on and -off of the heater lamps 41 and 42 is executed using this mechanism, the heater turn-on control circuit 29 can control the turn-on and -off of the heater lamps 41 and 42, individually.

A thermistor 45 is provided on a central portion of the heater roller 17. A thermistor 46 is provided on an end portion located in the longitudinal direction. The thermistors 45 and 46 are connected to the A/D converter control circuit 26.

The CPU 21 controls the printer 1. The ROM 22 stores, for example, programs that the CPU 21 executes. The RAM 23 stores, for example, a work area that is necessary when the CPU 21 executes a program stored in the ROM 22. The I/O port 24 is used for, for example, a connection to a device.

The three modes for the heating control of the heater roller 17 will be described. The warming-up mode 32 is an operation mode in which the heater roller 17 is heated from a cold start temperature to a print enabling temperature. The standby mode 33 is an operation mode in which the heater controller 17 is kept at the print enabling temperature and is waiting for a request for printing. The print mode 34 is an operation mode in which the heater roller 17 is controlled so as to execute thermal fixing for predetermined image printing.

A target temperature range, which is commonly necessary in each mode to enable the heater roller 17 to fix a developer image on a paper sheet P, is set as an upper limit target temperature (Tmax) and lower limit target temperature (Tmin).

The temperature detecting circuit 30 fetches the outputs of the thermistors 45 and 46 via the A/D converter control circuit 26, thereby detecting the surface temperature of the heater roller 17.

The timer 31 is started when the heater lamp 41 or 42 has been turned on. Further, the timer 31 is restarted when the temperature detected by the temperature detecting circuit 30 is lower than the lower limit target temperature (Tmin). The timer 31 stops when a time period preset for each of the aforementioned modes has elapsed. Different time periods are set for the aforementioned modes. The time period set for the warming-up mode 32 is t1. The time period set for the print mode 34 is t2. The time period set for the standby mode 33 is t3. The relationship between the thus-set time periods is t1<t2<t3.

A description will now be given of the heater roller temperature control logic used for each of the warming-up mode 32, standby mode 33 and print mode 34. In each mode, the turn-on and -off of the heater lamps 41 and 42 are determined on the basis of the time period t measured by the timer 31 and the temperature T detected by the temperature detecting circuit 30.

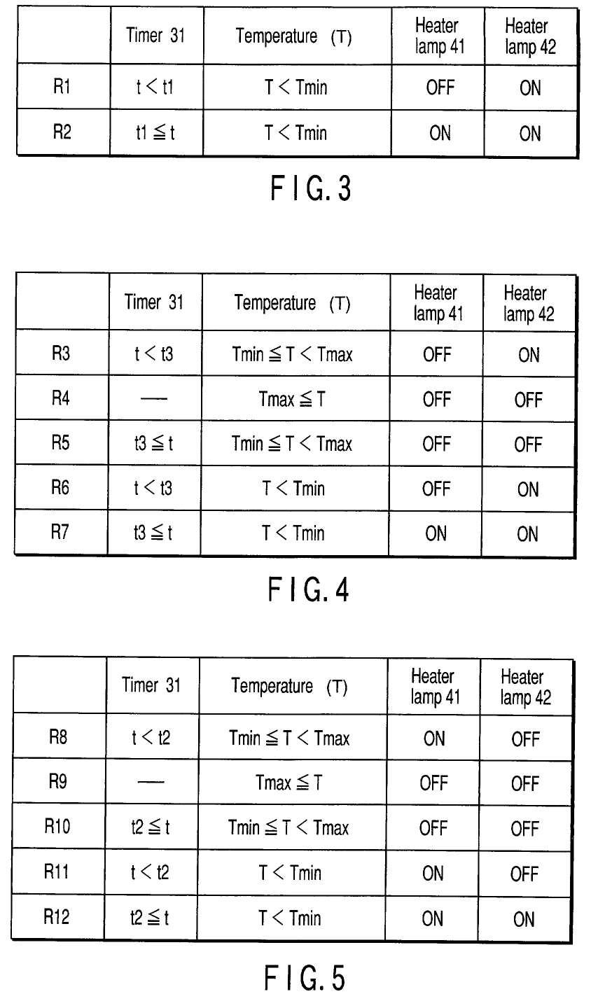

The temperature control logic for the warming-up mode 32 will be described. As illustrated in FIG. 3, if t<t1 and T<Tmin, the heater lamps 41 and 42 are OFF and ON, respectively (R1). If t1≦t and T<Tmin, the heater lamps 41 and 42 are both ON (R2).

The temperature control logic for the standby mode 33 will be described. As illustrated in FIG. 4, if t<t3 and Tmin<T<Tmax, the heater lamps 41 and 42 are OFF and ON, respectively (R3). If Tmax≦T, the heater lamps 41 and 42 are both OFF irrespective of the value of t measured by the timer 31 (R4). Further, even if Tmin<T <Tmax instead of Tmax≦T, if t3≦t, the heater lamps 41 and 42 are both OFF (R5). If t<t3 and T<Tmin, the heater lamps 41 and 42 are OFF and ON, respectively (R6). If t3≦t and T<Tmin, the heater lamps 41 and 42 are both ON (R7).

The temperature control logic for the print mode 34 will be described. As illustrated in FIG. 5, if t<t2 and Tmin<T<Tmax, the heater lamps 41 and 42 are ON and OFF, respectively (R8). If Tmax≦T, the heater lamps 41 and 42 are both OFF irrespective of the value of t measured by the timer 31 (R9). Further, even if Tmin<T<Tmax instead of Tmax≦T, if t2≦t, the heater lamps 41 and 42 are both OFF (R10). If t<t2 and T<Tmin, the heater lamps 41 and 42 are ON and OFF, respectively (R11). If t2≦t and T<Tmin, the heater lamps 41 and 42 are both ON (R12).

A description will be given of the turn-on and -off of the heater lamps 41 and 42 when the printer 1 executes printing in the print mode 34 after it operates in the warming-up mode 32 and standby mode 33.

In the warming-up mode 32, only the heater lamp 42 is turned on, and the timer 31 continues to count until the period t reaches the set time period t1 (R1). When the time period t measured by the timer 31 has reached the set time period t1, the heater lamp 42 is turned on (R2). Thus, the heater roller 17 is heated so that the temperature T exceeds the lower limit target temperature.

After the heater roller 17 is heated and the temperature T exceeds the lower limit target temperature, the mode is shifted to the standby mode 33. In the standby mode 33, the heater lamp 41 is turned off and only the heater lamp 42 is kept ON (R3). Upon the turn-off of one of the lamps, the timer 31 is restarted. When the temperature T has come to be equal or higher than the upper limit target temperature, both the heater lamps 41 and 42 are turned off irrespective of the time period t measured by the timer 31 (R4).

If the temperature T is not lower than the lower limit target temperature even after the time period t measured by the timer 31 within the target temperature range (between the upper and lower limit target temperatures) has reached the set time period t3, both the heater lamps 41 and 42 are turned off (R5). This operation is executed to prevent the heater lamps 41 and 42 from being kept ON due to a possible malfunction of the temperature detecting circuit 30.

If the temperature T is lower than the lower limit target temperature, the heater lamp 42 is turned on. If the heater lamp 42 is already turned on, the timer 31 is restarted to continue the ON state of the heater lamp 42 (R6). Where the temperature T is lower than the lower limit target temperature, and only the heater lamp 42 is in the ON state, if the temperature T does not reach the lower limit target temperature even after the time period t measured by the timer 31 has reached the set time period t3, the heater lamp 41 is turned on, as well as the heater lamp 42 (R7).

In the standby mode 33, if the printer 1 has received a request for printing, the mode is shifted to the print mode 34. In the print mode 34, if the temperature T is within the target temperature range and the time period t measured by the timer 31 is equal to or shorter than the set time period t2, only the heater lamp 41 is kept ON (R8). If the temperature T is equal to or higher than the upper limit target temperature, both the heater lamps 41 and 42 are turned off irrespective of the time period t measured by the timer 31 (R9).

If the temperature T is not lower than the lower limit target temperature even after the time period t measured by the timer 31 has reached the set time period t2, both the heater lamps 41 and 42 are turned off (R10). This operation is executed to prevent the heater lamps 41 and 42 from being kept ON because of the malfunction of the temperature detecting circuit 30.

If the temperature T is lower than the lower limit target temperature, the heater lamp 41 is turned on. If the heater lamp 41 is already turned on, the timer 31 is restarted to continue the ON state of the heater lamp 41 (R11). Where the temperature T is lower than the lower limit target temperature, and only the heater lamp 41 is in the ON state, if the temperature does not reach the lower limit target temperature even after the time period t measured by the timer 31 has reached the set time period t2, the heater lamp 42 is turned on, as well as the heater lamp 41 (R12).

After printing on a paper sheet is finished, the print mode 34 is ended and again returned to the standby mode 33, where the aforementioned standby mode operation is executed.

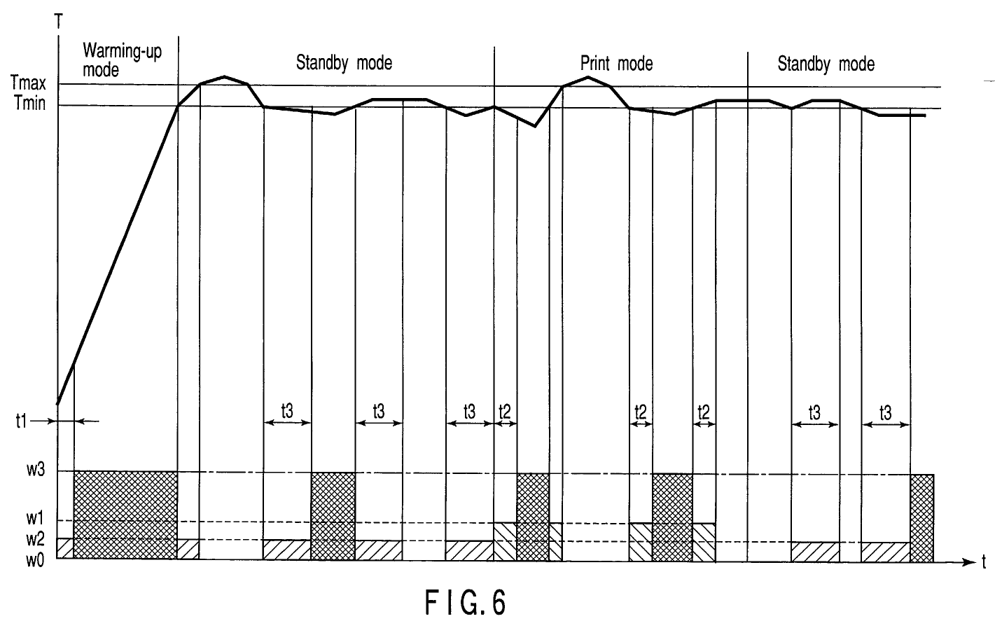

FIG. 6 is a graph illustrating the above-described temperature control logic, the ordinate indicating the time t, and the abscissa indicating the temperature T. Along the time axis t, the mode shift is shown, which is executed in the order of the warming-up mode 32, standby mode 33, print mode 34 and again standby mode 33. The temperature axis T indicates the upper limit target temperature (Tmax) and lower limit target temperature (Tmin). Also shown are the measurement start and end of each of the time period t1 set for the warming-up mode 32, time period t3 set for the standby mode 33, and time period t2 set for the print mode 34. Further, in FIG. 6, the vertical lines indicate control switching times.

Furthermore, the lower portion of the graph is a bar chart indicating power W for heating the heater roller 17. W0 indicates power used when both the heater lamps 41 and 42 are turned off, i.e., power of 0. W1 indicates power used when the heater lamp 41 is solely turned on. W2 indicates power used when only the heater lamp 42 is turned on. W3 indicates power used when both the heater lamps 41 and 42 are turned on.

As shown in FIG. 6, the power W for heating the heater roller 17 is applied thereto in a stepwise manner in the order of, for example, W0, W2, W1 and W3. In other words, there is neither the case where the heater lamps 41 and 42, which are both in the OFF state, are simultaneously turned on, nor the case where the heater lamps 41 and 42, which are both in the ON state, are simultaneously turned off.

By virtue of this structure, the temperature of the heater roller 17 is prevented from being abruptly increased or decreased, thereby suppressing overshooting or undershooting. As a result, the variations in the temperature control range and temperature ripple can be reduced.

In the above embodiment, since the heater lamp 42 of a lower rated power is first turned on at the cold start, and the heater lamp 41 of a higher rated power is turned on the time period t1 after, the occurrence of an inrush current can be avoided as compared to the case where the heater lamp 41 of the higher rated power is solely turned on at the cold start.

In the standby mode 33, as the heater lamp 42 of a lower rated power than the heater lamp 41 is turned on in preference to the latter, the power consumption can be reduced.

In the print mode 34, as the heater lamp 41 of a higher rated power than the heater lamp 42 is turned on in preference to the latter, the time required to increase the temperature to a target temperature range can be reduced.

Further, since the rated power to be applied to the heater roller 17 can be switched in a stepwise manner, the temperature change becomes smooth, thereby reducing the temperature ripple in the warming-up mode 32, standby mode 33 and print mode 34. This means that the temperature ripple that occurs during the heat control of the heater roller 17 from the turn-on to the turn-off of the printer 1 can be reduced.

In the above-described embodiment, the image forming apparatus of the invention is a printer. However, the invention is not limited to this, but may be a copy machine, complex apparatus, facsimile, etc., in which a predetermined image is thermally fixed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus for forming a predetermined image, comprising:
a to-be-heated object which thermally fixes an image transferred onto a paper sheet;
a first heater lamp which heats the to-be-heated object with a predetermined rated power;
a second heater lamp which heats the to-be-heated object with a rated power lower than the predetermined rated power;
a timer section which measures time;
a detecting section which detects a temperature of the to-be-heated object; and
a warming-up mode which is an operation mode in which the to-be-heated object is heated from a cold start temperature to a predetermined temperature,
wherein, in the warming-up mode, the second heater lamp is turned on and time measurement is started, and the first heater lamp is turned on after a predetermined time period t1 elapses, thereby heating the to-be-heated object to the predetermined temperature.

2. An image forming apparatus for executing predetermined image forming, comprising:
a to-be-heated object which thermally fixes an image transferred onto a paper sheet;
a first heater lamp which heats the to-be-heated object with a predetermined rated power;
a second heater lamp which heats the to-be-heated object with a rated power lower than the predetermined rated power;
a timer section which measures time;
a detecting section which detects a temperature of the to-be-heated object; and
a standby mode which is an operation mode in which the to-be-heated object is maintained at a print-enabling temperature, and a request for printing is waited for,
wherein, in the standby mode, turn-on and turn-off of the second heater lamp is executed preferentially, and the second heater lamp is turned on and time measurement is started, the first heater lamp being turned on if a preset target temperature is not reached even after a predetermined time period t3 elapses, thereby heating the to-be-heated object to a temperature falling within a predetermined range.

3. An image forming apparatus for executing predetermined image forming, comprising:
a to-be-heated object which thermally fixes an image transferred onto a paper sheet;
a first heater lamp which heats the to-be-heated object with a predetermined rated power;
a second heater lamp which heats the to-be-heated object with a rated power lower than the predetermined rated power;
a timer section which measures time;
a detecting section which detects a temperature of the to-be-heated object; and
a print mode which is an operation mode for predetermined image printing, in which the to-be-heated object is controlled to execute thermal fixing,
wherein, in the print mode, turn-on and turn-off of the first heater lamp is executed preferentially, and the first heater lamp is turned on and time measurement is started, the second heater lamp being turned on if a preset target temperature is not reached even after a predetermined time period t2 elapses, thereby heating the to-be-heated object to a temperature falling within a predetermined range.

4. An image forming apparatus according to claim 1, further comprising:
a standby mode which is an operation mode in which the to-be-heated object is maintained at a print-enabling temperature, and a request for printing is waited for, and
a print mode which is an operation mode for predetermined image printing, in which the to-be-heated object is controlled to execute thermal fixing,
and wherein:
in the standby mode, turn-on and turn-off of the second heater lamp is executed preferentially, and the second heater lamp is turned on and time measurement is started, the first heater lamp being turned on if a preset target temperature is not reached even after a predetermined time period t3 elapses, thereby heating the to-be-heated object to a temperature falling within a predetermined range; and
in the print mode, turn-on and turn-off of the first heater lamp is executed preferentially, and the first heater lamp is turned on and time measurement is started, the second heater lamp being turned on if a preset target temperature is not reached even after a predetermined time period t2 elapses, thereby heating the to-be-heated object to a temperature falling within a predetermined range.

5. An image forming apparatus according to claim 4, wherein the relationship between the predetermined time period t1 set in the warming-up mode, the predetermined time period t3 set in the standby mode, and the predetermined time period t2 set in the print mode is t1<t2<t3.
